(19) United States
(12) Patent Application Publication
(10) Pub. No.: US 2017/0330069 A1
(43) Pub. Date: Nov. 16, 2017

(54) MULTI-LAYER ARTIFICIAL NEURAL NETWORK AND CONTROLLING METHOD THEREOF

(71) Applicant: Kneron Inc., San Diego, CA (US)

(72) Inventor: Chun-Chen Liu, San Diego, CA (US)

(21) Appl. No.: 15/152,528

(22) Filed: May 11, 2016

(51) Int. Cl. G06N 3/063; G06N 3/04

(52) U.S. Cl. CPC G06N 3/063; G06N 3/04

(57) ABSTRACT

A multi-layer artificial neural network including a plurality of artificial neurons, a storage device, and a controller is provided. The plurality of artificial neurons are used for performing computation based on plural parameters. The storage device is used for storing plural sets of parameters, each set of parameters being corresponding to a respective layer. At a first time instant, the controller controls the storage device to provide a set of parameters corresponding to a first layer to the plurality of artificial neurons so that the plurality of artificial neurons form at least part of the first layer. At a second time instant, the controller controls the storage device to provide a set of parameters corresponding to a second layer to the plurality of artificial neurons so that the plurality of artificial neurons format least part of the second layer.

### BACKGROUND OF THE INVENTION

### 1. Field of the Invention

The present invention relates to artificial neural networks. In particular, the present invention relates to multi-layer artificial neural networks capable of performing deep learning.

### 2. Description of the Prior Art

The idea of artificial neural networks has existed for a long time. Nevertheless, limited computation ability of hardware had been an obstacle to related researches. Over the last decade, there are significant progresses in computation capabilities of processors and algorithms of machine learning. Not until recently did an artificial neural network that can generate reliable judgments become possible. Gradually, artificial neural networks are experimented in many fields such as autonomous vehicles, image recognition, natural language understanding, and data mining.

Neurons are the basic computation units in a brain. Each neuron receives input signals from its dendrites and produces output signals along its single axon (usually provided to other neurons as input signals). The typical operation of an artificial neuron can be modeled as:

$$y = f ( {\sum }_{i} {W}_{i} {X}_{i} + b )$$

wherein x represents the input signal, y represents the output signal. Each dendrite multiplies a weight w to its input signal x; this parameter is used to simulate the strength of influence of one neuron on another. The symbol b represents a bias contributed by the artificial neuron itself. The symbol f represents a specific nonlinear function and is generally implemented as a sigmoid function, tan h function, or rectified linear function in practical computation.

For an artificial neural network, the relationship between its input data and final judgment is in effect defined by the weights and biases of all the artificial neurons in the network. In an artificial neural network adopting supervised learning, training samples are fed to the network. Then, the weights and biases of artificial neurons are adjusted with the goal to find out a judgment policy that the judgments can match the training samples. In an artificial neural network adopting unsupervised learning, whether a judgment matches the training sample is unknown. The network adjusts the weights and biases of artificial neurons and tries to find out an underlying rule. No matter which kind of learning is adopted, the goals are the same—finding out suitable parameters (i.e. weights and biases) for each neuron in the network. The determined parameters will be utilized in future computation.

Currently, most artificial neural networks are designed as having a multi-layer structure. Layers serially connected between the input layer and the output layer are called hidden layers. The input layer receives external data and does not perform computation. In a hidden layer or the output layer, input signals are the output signals generated by its previous layer, and each artificial neuron included therein respectively performs computation according to the aforementioned equation. Each hidden layer and output layer can respectively be a convolutional layer or a fully-connected layer. The main difference between a convolutional layer and a fully-connected layer is that neurons in a fully connected layer have full connections to all neurons in its previous layer. On the contrary, neurons in a convolutional layer are connected only to a local region of its previous layer. Besides, many artificial neurons in a convolutional layer share parameters.

At the present time, there are a variety of network structures. Each structure has its unique combination of convolutional layers and fully-connected layers. Taking the AlexNet structure proposed by Alex Krizhevsky et al. in 2012 as an example, the network includes 650,000 artificial neurons that form five convolutional layers and three fully-connected layers connected in serial.

Generally speaking, as the number of layers increases, an artificial neural network can simulate a more complicated function (i.e. a more complicated judgment policy). However, as the number of layers increases, the number of artificial neurons required in the network would swell significantly and introduce a huge burden in the hardware cost. Undoubtedly, this difficulty will be an impediment to applying artificial neural networks to consumer electronics in the future.

### SUMMARY OF THE INVENTION

To solve the aforementioned problem, a new multi-layer artificial neural network and controlling method thereof are provided.

One embodiment according to the invention is a multi-layer artificial neural network including a plurality of artificial neurons, a storage device, and a controller. The plurality of artificial neurons are used for performing computation based on plural parameters. The storage device is used for storing plural sets of parameters; each set of parameters is corresponding to a respective layer. At a first time instant, the controller controls the storage device to provide a set of parameters corresponding to a first layer to the plurality of artificial neurons so that the plurality of artificial neurons format least part of the first layer. At a second time instant, the controller controls the storage device to provide a set of parameters corresponding to a second layer to the plurality of artificial neurons so that the plurality of artificial neurons form at least part of the second layer.

Another embodiment according to the invention is a controlling method for a multi-layer artificial neural network. The multi-layer artificial neural network includes a plurality of artificial neurons for performing computation based on plural parameters. According to the controlling method, at a first time instant, a set of parameters corresponding to a first layer is provided to the plurality of artificial neurons so that the plurality of artificial neurons form at least part of the first layer. Further, at a second time instant, a set of parameters corresponding to a second layer is provided to the plurality of artificial neurons so that the plurality of artificial neurons form at least part of the second layer.

Another embodiment according to the invention is a non-transitory computer-readable storage medium encoded with a computer program for controlling a multi-layer artificial neural network. The multi-layer artificial neural network includes a plurality of artificial neurons for performing computation based on plural parameters. The computer program includes instructions that when executed by one or more computers cause the one or more computers to perform operations including: at a first time instant, providing a set of parameters corresponding to a first layer to the plurality of artificial neurons so that the plurality of artificial neurons form at least part of the first layer; and at a second time instant, providing a set of parameters corresponding to a second layer to the plurality of artificial neurons so that the plurality of artificial neurons form at least part of the second layer.

The advantage and spirit of the invention may be understood by the following recitations together with the appended drawings.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a three-layer artificial neural network as an example.

FIG. 2A is the block diagram of an artificial neural network according to the invention; FIG. 2B˜FIG. 2D illustrate the configurations of this multi-layer artificial neural network at different time instants.

FIG. 3 shows an alternative artificial neural network according to the invention.

FIG. 4 shows another artificial neural network according to the invention.

FIG. 5 shows a multi-layer artificial neural network including an input analyzer.

FIG. 6 is the flowchart of a controlling method for a multi-layer artificial neural network according to the invention.

The figures described herein include schematic block diagrams illustrating various interoperating functional modules. It should be noted that such diagrams are not intended to serve as electrical schematics and interconnections illustrated are intended to depict signal flow, various interoperations between functional components and/or processes and are not necessarily direct electrical connections between such components. Moreover, the functionality illustrated and described via separate components need not be distributed as shown, and the discrete blocks in the diagrams are not necessarily intended to depict discrete electrical components.

### DETAILED DESCRIPTION

One embodiment according to the invention is a multi-layer artificial neural network including a plurality of artificial neurons, a storage device, and a controller. The controller is designed to request the storage device to, at different time instants, provide parameters corresponding to different layers to those artificial neurons.

FIG. 1 shows a three-layer artificial neural network as an example. It should be noted that although actual artificial neural networks include much more artificial neurons and have much more complicated interconnections than this example, those ordinarily skilled in the art can understand, through the following introduction, the scope of the invention is not limited to a specific network complexity. Please refer to FIG. 1. The input layer 110 is used for receiving external data D1˜D3. There are two hidden layers between the input layer 110 and the output layer 140. The hidden layers 120 and 130 are fully-connected layers. The hidden layer 120 includes four artificial neuron (121˜124) and the hidden layer 130 includes two artificial neuron (131˜132). The output layer 140 includes only one artificial neuron (141).

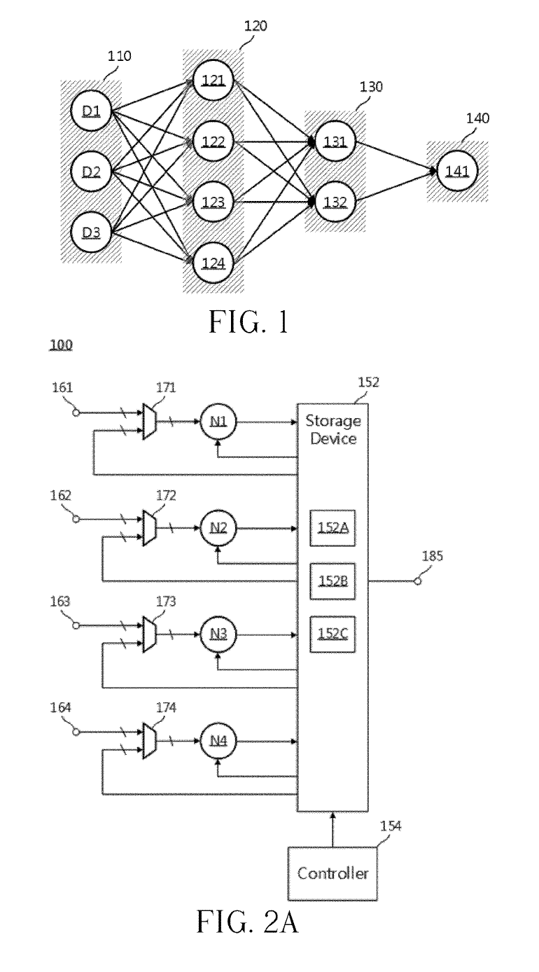

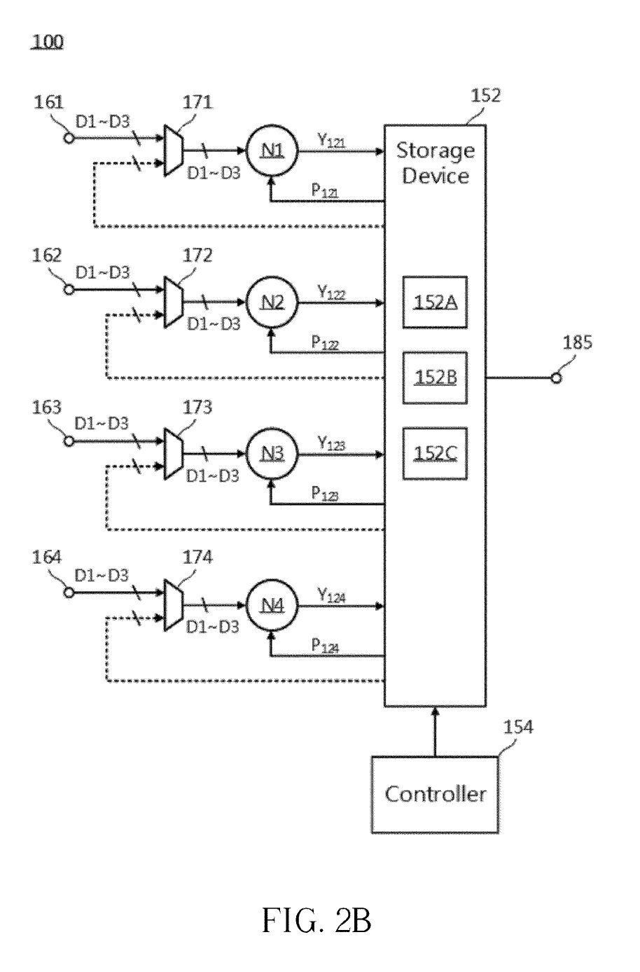

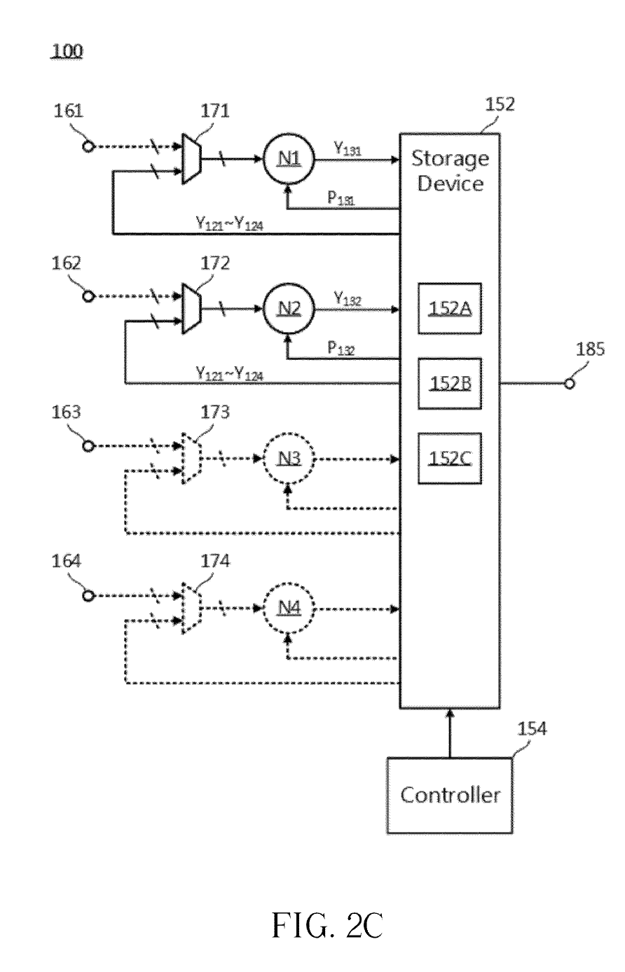

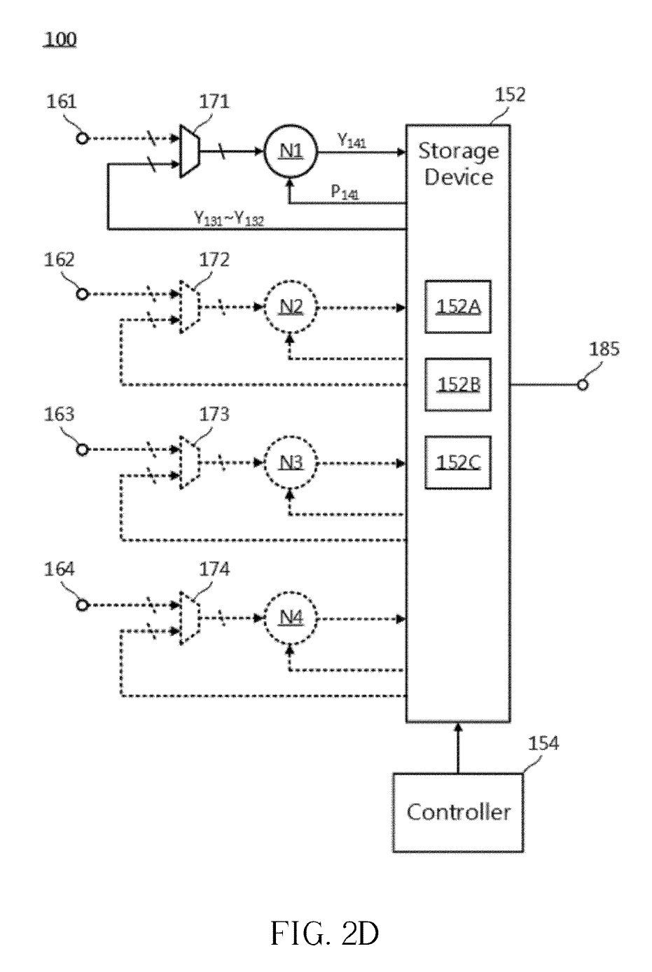

FIG. 2A shows an artificial neural network implemented according to the invention. The artificial neural network 100 includes four artificial neurons (N1˜N4), a storage device 152, a controller 154, input pins 161˜164, and a reconfigurable routing circuit formed by multiplexers 171˜174. The artificial neurons N1˜N4 can be configured to implement the hidden layer 120, 130 and output layer 140 in FIG. 1, as detailed below.

As described above, each artificial neuron performs computation based on its input signals and respective parameters (weights and biases). In the process of machine learning, no matter the learning strategy includes only forward propagation or both forward propagation and backpropagation, these parameters might be continuously adjusted. During and after the learning process, the storage device 152 in FIG. 2A is responsible for storing the latest parameters for artificial neurons in the hidden layer 120, 130 and output layer 140. For example, the storage device 152 can, as shown in FIG. 2A, includes three storage regions. The storage region 152A is used for storing parameters corresponding to artificial neurons 121˜124 in the hidden layer 120, the storage region 152B is used for storing parameters corresponding to artificial neurons 131˜132 in the hidden layer 130, and the storage region 152C is used for storing parameters corresponding to artificial neuron 141 in the output layer 140. The scope of the invention is not limited to specific storage mechanisms. Practically, the storage device 152 can include one or more volatile or non-volatile memory device, such as a dynamic random access memory (DRAM), a magnetic memory, an optical memory, a flash memory, etc. Physically, the storage device 152 can be a single device or be separated into plural smaller storage units disposed adjacent to the artificial neurons N1˜N4, respectively.

The input pins 161˜164 respectively receive the external data D1˜D3. First, at a time instant t1, the controller 154 requests the storage device 152 to provide parameters corresponding to hidden layer 120 (i.e. parameters stored in the storage region 152A) to the artificial neurons N1˜N4. For example, the controller 154 can request the storage device 152 to provide parameters corresponding to the artificial neuron 121 (so the parameters are labeled as P121) to the artificial neuron N1. As shown in FIG. 1, the artificial neuron 121 has three input terminals. Accordingly, the parameters P121 include one bias b and three weights w. And so on, the controller 154 can request the storage device 152 to provide parameters corresponding to the artificial neuron 122 (labeled as P122) to the artificial neuron N2, provide parameters corresponding to the artificial neuron 123 (labeled as P123) to the artificial neuron N3, and provide parameters corresponding to the artificial neuron 124 (labeled as P124) to the artificial neuron N4.

The multiplexers 171˜174 are also controlled by the controller 154 (via connections omitted in these figures). At the time instant t1, the controller 154 controls multiplexers 171˜174 to connect input pins 161˜164 with artificial neurons N1˜N4, so that the external data D1˜D3 is provided to the artificial neurons N1˜N4 as input signals. FIG. 2B shows the configuration of the artificial neural network 100 at the time instant t1. In this configuration, the artificial neurons N1˜N4 are configured to act as the artificial neurons 121˜124 in the hidden layer 120. After the artificial neurons N1˜N4 complete the computation task corresponding to the hidden layer 120, the four computation results Y121˜Y124 generated by the artificial neurons N1˜N4 are transferred to and stored in the storage device 152 (for example, into the storage region 152A).

Then, at a time instant t2, the controller 154 controls the storage device 152 to provide parameters corresponding to the hidden layer 130 (i.e. parameters stored in the storage region 152B) to the artificial neurons N1˜N2. For example, the controller 154 can request the storage device 152 to provide parameters corresponding to the artificial neuron 131 (labeled as P131) to the artificial neuron N1, and provide parameters corresponding to the artificial neuron 132 (labeled as P132) to the artificial neuron N2. Further, the controller 154 also controls multiplexers 171˜172 to connect the storage device 152 with the artificial neurons N1˜N2, and requests the storage device 152 to provide previously stored computation results Y121˜Y124 to the artificial neurons N1˜N2 as input signals. FIG. 2C shows the configuration of the artificial neural network 100 at the time instant t2. In this configuration, the artificial neurons N1˜N2 are configured to act as the artificial neurons 131˜132 in the hidden layer 130, and the artificial neurons N3˜N4 are not utilized. After the artificial neurons N1˜N2 complete the computation task corresponding to the hidden layer 130, the two computation results Y131˜Y132 generated by the artificial neurons N1˜N2 are transferred to and stored in the storage device 152 (for example, into the storage region 152B).

Subsequently, at a time instant t3, the controller 154 requests the storage device 152 to provide parameters corresponding to the artificial neuron 141 (labeled as P141) to the artificial neurons N1. Further, the controller 154 also controls the multiplexer 171 to connect the storage device 152 with the artificial neuron N1, and requests the storage device 152 to provide previously stored computation results Y131˜Y132 to the artificial neuron N1 as input signals. FIG. 2D shows the configuration of the artificial neural network 100 at the time instant t3. In this configuration, the artificial neuron N1 is configured to act as the artificial neuron 141 in the output layer 140, and the artificial neurons N2˜N4 are not utilized. After the artificial neuron N1 completes the computation task corresponding to the output layer 140, the computation result Y141 is the judgment of the artificial neural network 100 on the external data D1˜D3. The computation result Y141 can be transferred to and stored in the storage device 152 (for example, into the storage region 152C) or be transferred to a following circuit via the output pin 185 of the storage device 152.

It should be noted the time instants t1, t2, and t3 are usually relative time instants instead of absolute time instants. For example, the time instant t2 can be defined as the time instant after a certain number of clock cycles counted since the time instant t1. Practically, circuit designers can estimate an appropriate interval between the time instants t1 and t2 based on the computation speed of the artificial neurons N1˜N4 and the signal latency between the blocks. Alternatively, the time instant t2 can be set as the time instant when the computation relative to the hidden layer 120 ends. In other words, the time instant t2 can be triggered by the end of computation relative to the hidden layer 120.

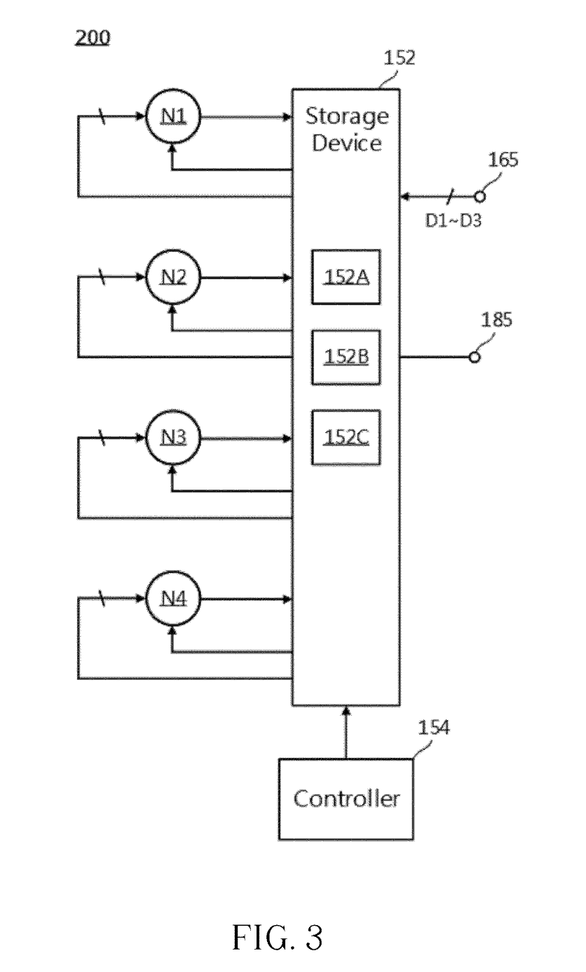

FIG. 3 shows an alternative embodiment of the artificial neural network 100. The main difference between the artificial neural networks 200 and 100 is that the external data D1˜D3 is sent into the storage device 152 via the input pin 165 instead of being directly provided to the artificial neurons N1˜N4. Hence, at the time instant t1, the controller 154 in the artificial neural network 200 requests the storage device 152 to provide the external data D1˜D3 to the artificial neurons N1˜N4 as input signals. In this embodiment, the multiplexers 171˜174 in the artificial neural network 100 are not necessary.

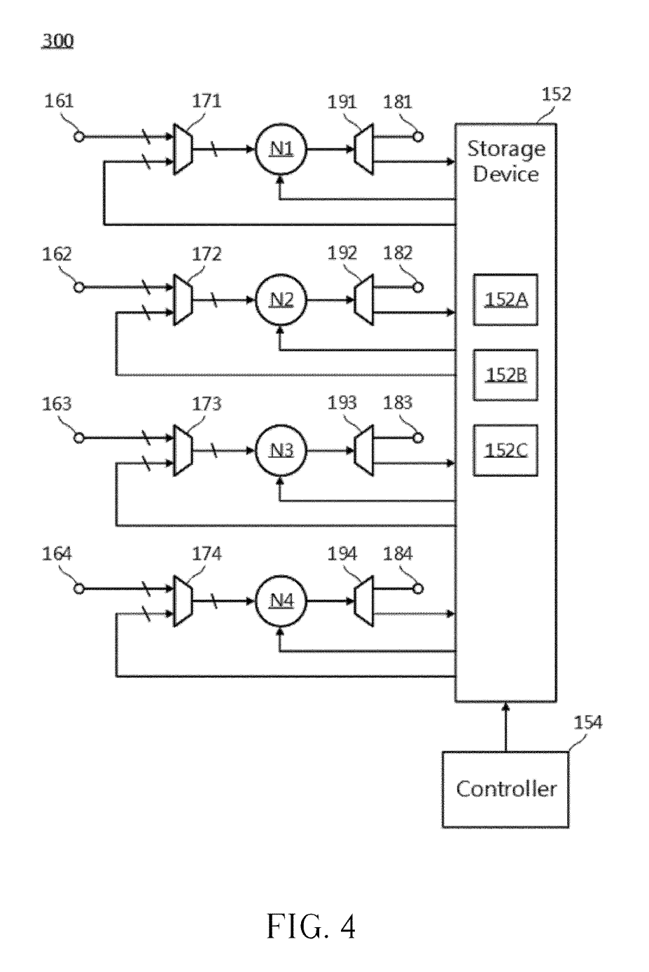

FIG. 4 shows another alternative embodiment of the artificial neural network 100. The main difference between the artificial neural networks 300 and 100 is that the artificial neural network 300 further includes output pins 181˜184 and a reconfigurable routing circuit formed by multiplexers 191˜194. The multiplexers 191˜194 are also controlled by the controller 154 (via connections omitted in the figures). By controlling the multiplexers 191˜194, the controller 154 can determine whether to store the computation results of the artificial neurons N1˜N4 into the storage device 152 or to send the computation results out via the output pins 181˜184. For example, the controller 154 can request the computation results Y121˜Y124 and Y131˜Y132 corresponding to the hidden layers 120 and 130 to be stored into the storage device 152, but request the computation result Y141 corresponding to the output layer 140 to be send out via the output pin 181.

It can be seen through the above descriptions, no matter whether input signals of the artificial neurons N1˜N4 are provided from the storage device 152, and no matter whether computation results of the artificial neurons N1˜N4 are stored into the storage device 152, as long as the controller 154 changes parameters provided to the artificial neurons N1˜N4, the artificial neurons N1˜N4 can be reconfigured to work for a different layer. Although the artificial neural networks 100, 200, 300 do not have multiple fixed layers physically, these networks can be configured to complete computation tasks of multiple layers sequentially. Compared with prior arts, artificial neural networks according to the invention obviously can utilize fewer artificial neurons while generate the same computation results. Thereby, the hardware cost is significantly reduced.

It should be noted that the detailed computation in the artificial neurons and how their parameters are adjusted in the learning process are known by those ordinarily skilled in the art and not further described hereinafter. The scope of the invention is not limited to these computation details.

In practical applications, the interconnections between the artificial neurons N1˜N4 and the storage device 152 can be implemented by a high-speed communication interface, so as to reduce time for retrieving and storing data. The overall operation speed of the artificial neural networks 100, 200, 300 can accordingly be increased. For example, the high-speed communication interface can be but not limited to a serializer-deserializer (SERDES) interface or a radio frequency interface (RFI).

As shown above, the reconfigurable artificial neurons may form a complete fully-connected layer. Alternatively, the reconfigurable artificial neurons may also form one part of a fully-connected layer and the other part of the fully-connected layer is formed by artificial neurons with fixed configuration. Similarly, the reconfigurable artificial neurons may form one part or all of a convolutional layer.

Moreover, the scope of the invention is not limited to the number of reconfigurable artificial neurons, either. Although FIG. 2A˜FIG. 4 show examples with four artificial neurons, there is not an upper limit to the number of reconfigurable artificial neurons in an artificial neural network according to the invention. For example, the network can include thousands or tens of thousands of reconfigurable artificial neurons at the same time.

Furthermore, besides the reconfigurable artificial neurons, the storage device, and the controller, artificial neural networks according to the invention can include other circuits, such as but not limited to a pooling layer connected subsequent to a convolutional layer and an oscillator for generating clock signals. Those ordinarily skilled in the art can comprehend that the scope of the invention is not limited to a specific network structure. An artificial neural network according to the invention can be used to implement but not limited to the following network structures: the LeNet proposed by Yann LeCun, the AlexNet proposed by Alex Krizhevsky et al., the ZF Net proposed by Matthew Zeiler et al., the GoogLeNet proposed by Szegedy et al., the VGGNet proposed by Karen Simonyan et al., and the ResNet proposed by Kaiming He et al.

Practically, the controller 154 can be implemented by a variety of processing platforms. Fixed and/or programmable logic, such as field-programmable logic, application-specific integrated circuits, microcontrollers, microprocessors and digital signal processors, may be included in the controller 154. Embodiments of the controller 154 may also be fabricated to execute a process stored in a memory (not illustrated) as executable processor instructions.

Moreover, the controller 154 can be designed as controlling the storage device 152 and other configurable routing circuits (if needed) according to a configuration file predetermined by circuit designers. The content of the configuration file indicates at which time instant should the controller 154 reconfigure the artificial neurons N1˜N4 to which layer.

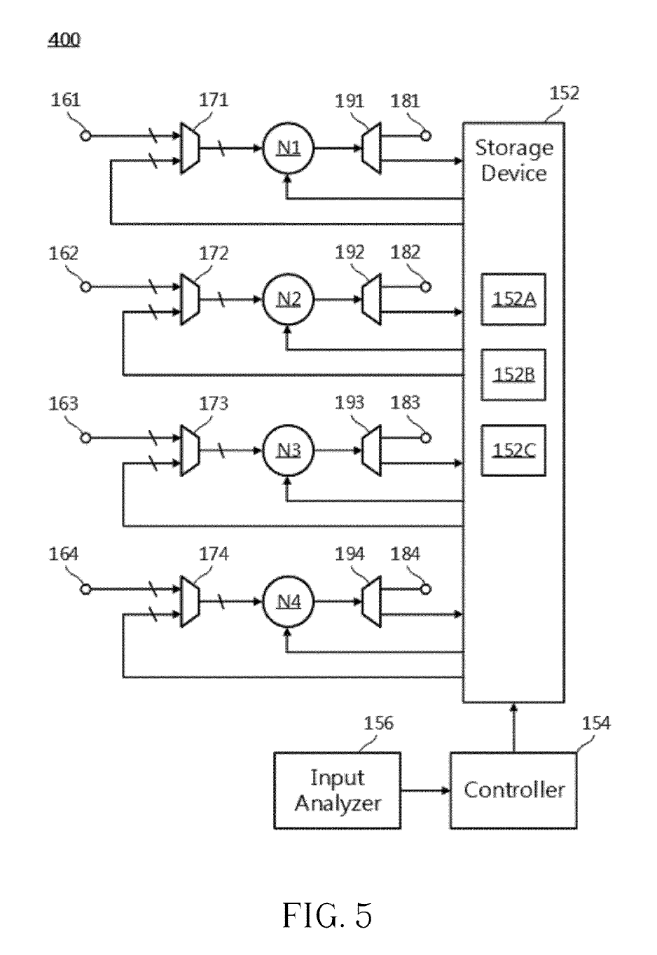

In an alternative embodiment, the controller 154 is designed as operating according to a configuration file adaptively determined based on the property of external data. Please refer to FIG. 5. The main difference between the artificial neural networks 300 and 400 is that the artificial neural network 400 further includes an input analyzer 156. The input analyzer 156 is used for analyzing external data to be processed by the artificial neural network 400 and accordingly determines a configuration for the artificial neural network 400. For example, the configuration determined by the input analyzer 156 can includes a total number of layers in the artificial neural network 400 and how many convolutional layers and/or fully-connected layers should be included in this network. As described above, as long as the controller 154 changes parameters provided from the storage device 152 to the reconfigurable artificial neurons, those neurons can then be reconfigured to work for a different layer. Therefore, there is not an upper limit to the total number of layers can be provided by the artificial neural network 400. Moreover, the number of artificial neurons in each layer can also be adaptively adjusted.

In prior arts, the hardware structure of an artificial neural network is usually predetermined based on the property of data to be processed. More specifically, an artificial neural network in prior arts generally has a fixed hardware structure and fixed circuits. Different from prior arts, the artificial neural network 400 provides a more flexible solution that one or more of the following factors can be adjusted: the network structure, the number of layers, the number of artificial neurons in each layer, the connections between artificial neurons. Therefore, the artificial neural network 400 can be not bonded to a specific application. Aiming at external data with pure properties, the input analyzer 156 can determine a configuration with fewer layers for the artificial neural network 400, so as to save computation resources and prevent overfitting. On the contrary, aiming at external data with complicated properties, the input analyzer 156 can determine a configuration with more layers for the artificial neural network 400, so as to make the judgments more matching to the external data.

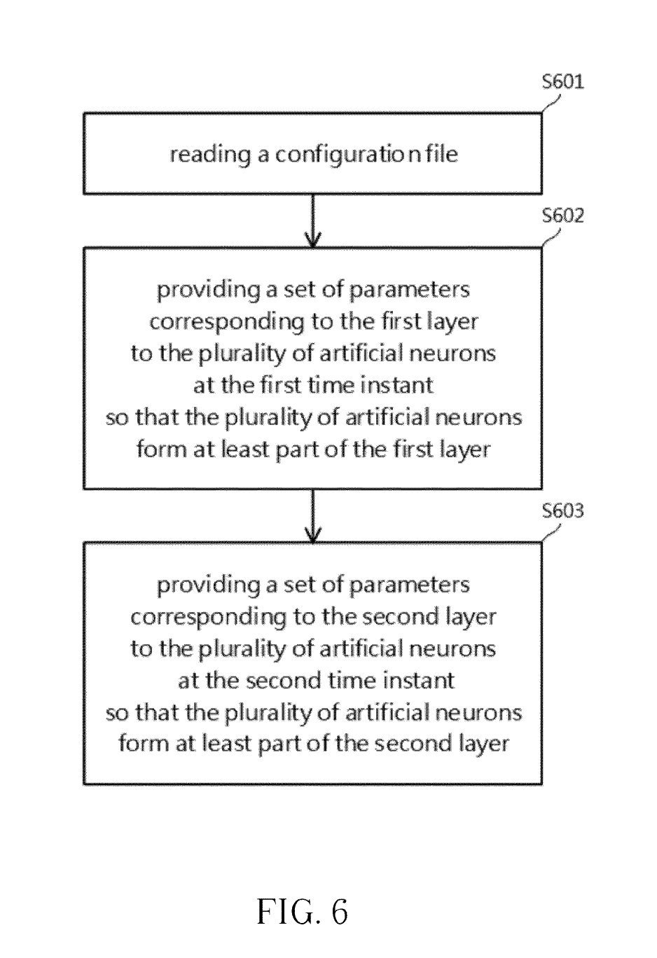

Another embodiment according to the invention is a controlling method for a multi-layer artificial neural network. The multi-layer artificial neural network includes a plurality of artificial neurons for performing computation based on plural parameters. FIG. 6 shows the flowchart of the controlling method. First, step S601 is reading a configuration file. The content of the configuration file indicates a first time instant corresponding to a first layer and a second time instant corresponding to a second layer. Then, step S602 is providing a set of parameters corresponding to the first layer to the plurality of artificial neurons at the first time instant so that the plurality of artificial neurons form at least part of the first layer. Subsequently, step S603 is providing a set of parameters corresponding to the second layer to the plurality of artificial neurons at the second time instant so that the plurality of artificial neurons form at least part of the second layer. It should be noted that the first time instant and second time instant are usually relative instead of absolute time instants. For example, the second time instant can be defined as the time instant after a certain number of clock cycles counted since the first time instant. Alternatively, the second time instant can be set as the time instant when the computation relative to step S602 ends and is triggered by the end of the computation. Those ordinarily skilled in the art can comprehend that the variety of variations relative to the artificial neural network 100 can also be applied to the controlling method in FIG. 6 and the details are not described again.

Another embodiment according to the invention is a non-transitory computer-readable storage medium encoded with a computer program for controlling a multi-layer artificial neural network. The multi-layer artificial neural network includes a plurality of artificial neurons for performing computation based on plural parameters. The computer program includes instructions that when executed by one or more computers cause the one or more computers to perform operations including: at a first time instant, providing a set of parameters corresponding to a first layer to the plurality of artificial neurons so that the plurality of artificial neurons form at least part of the first layer; and at a second time instant, providing a set of parameters corresponding to a second layer to the plurality of artificial neurons so that the plurality of artificial neurons form at least part of the second layer.

Practically, the aforementioned computer-readable storage medium may be any non-transitory medium on which the instructions maybe encoded and then subsequently retrieved, decoded and executed by a processor, including electrical, magnetic and optical storage devices. Examples of non-transitory computer-readable recording media include, but not limited to, read-only memory (ROM), random-access memory (RAM), and other electrical storage; CD-ROM, DVD, and other optical storage; and magnetic tape, floppy disks, hard disks and other magnetic storage. The processor instructions may be derived from algorithmic constructions in various programming languages that realize the present general inventive concept as exemplified by the embodiments described above. The variety of variations relative to the artificial neural network 100 can also be applied to the non-transitory computer-readable storage medium and the details are not described again.

With the example and explanations above, the features and spirits of the invention will be hopefully well described. Those ordinarily skilled in the art will readily observe that numerous modifications and alterations of the device may be made while retaining the teaching of the invention. Accordingly, the above disclosure should be construed as limited only by the metes and bounds of the appended claims. Additionally, mathematical expressions are contained herein and those principles conveyed thereby are to be taken as being thoroughly described therewith. It is to be understood that where mathematics are used, such is for succinct description of the underlying principles being explained and, unless otherwise expressed, no other purpose is implied or should be inferred. It will be clear from this disclosure overall how the mathematics herein pertain to the present invention and, where embodiment of the principles underlying the mathematical expressions is intended, the ordinarily skilled artisan will recognize numerous techniques to carry out physical manifestations of the principles being mathematically expressed.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-layer artificial neural network, comprising:
a plurality of artificial neurons for performing computation based on plural parameters;
a storage device for storing plural sets of parameters, each set of parameters being corresponding to a respective layer; and
a controller, at a first time instant, controlling the storage device to provide a set of parameters corresponding to a first layer to the plurality of artificial neurons so that the plurality of artificial neurons form at least part of the first layer, and at a second time instant, controlling the storage device to provide a set of parameters corresponding to a second layer to the plurality of artificial neurons so that the plurality of artificial neurons form at least part of the second layer.

2. The multi-layer artificial neural network of claim 1, wherein the storage device is further used for temporarily storing one or more sets of data; at the second time instant, the controller also controls the storage device to provide a set of stored data corresponding to the second layer to the plurality of artificial neurons as input signals.

3. The multi-layer artificial neural network of claim 2, wherein the one or more sets of data stored in the storage device are previously generated by the plurality of artificial neurons and transmitted to the storage device.

4. The multi-layer artificial neural network of claim 2, further comprising:
input pins for receiving external data; and
a configurable routing circuit disposed between the input pins, the storage device, and the plurality of artificial neurons;
wherein at the first time instant, the controller controls the configurable routing circuit to connect the input pins with the plurality of artificial neurons so as to provide the external data to the plurality of artificial neurons as input signals; at the second time instant, the controller controls the configurable routing circuit to connect the storage device with the plurality of artificial neurons so as to provide the set of stored data corresponding to the second layer to the plurality of artificial neurons as input signals.

5. The multi-layer artificial neural network of claim 4, wherein the one or more sets of data stored in the storage device are previously generated by the plurality of artificial neurons and transmitted to the storage device.

6. The multi-layer artificial neural network of claim 1, further comprising:
output pins; and
a configurable routing circuit disposed between the output pins, the storage device, and the plurality of artificial neurons;
wherein the controller controls the configurable routing circuit so that computation results of the plurality of artificial neurons are transmitted from the plurality of artificial neurons selectively to the output pins or the storage device.

7. The multi-layer artificial neural network of claim 1, wherein the first layer is a convolutional layer or a fully-connected layer.

8. The multi-layer artificial neural network of claim 1, further comprising:
an input analyzer for analyzing inputs of said multi-layer artificial neural network and accordingly determining a configuration for said multi-layer artificial neural network;
wherein the controller operates based on the configuration determined by the input analyzer.

9. The multi-layer artificial neural network of claim 8, wherein the configuration determined by the input analyzer comprises a total number of layers of said multi-layer artificial neural network.

10. The multi-layer artificial neural network of claim 1, wherein interconnections between the plurality of artificial neurons and the storage device are implemented by a high-speed communication interface.

11. A controlling method for a multi-layer artificial neural network comprising a plurality of artificial neurons, the plurality of artificial neurons being used for performing computation based on plural parameters, the controlling method comprising:
at a first time instant, providing a set of parameters corresponding to a first layer to the plurality of artificial neurons so that the plurality of artificial neurons form at least part of the first layer; and
at a second time instant, providing a set of parameters corresponding to a second layer to the plurality of artificial neurons so that the plurality of artificial neurons form at least part of the second layer.

12. The controlling method of claim 11, further comprising:
controlling a configurable routing circuit coupled to the plurality of artificial neurons, so as to select input signals for the plurality of artificial neurons from either external data or previously stored internal data.

13. The controlling method of claim 12, wherein the previously stored internal data are generated by the plurality of artificial neurons.

14. The controlling method of claim 11, further comprising:
controlling a configurable routing circuit coupled to the plurality of artificial neurons, so as to determine whether computation results of the plurality of artificial neurons are transmitted to external or not.

15. The controlling method of claim 11, wherein the first layer is a convolutional layer or a fully-connected layer.

16. The controlling method of claim 11, further comprising:
analyzing external data of said multi-layer artificial neural network and accordingly determining a configuration for said multi-layer artificial neural network.

17. The controlling method of claim 16, wherein the determined configuration comprises a total number of layers of said multi-layer artificial neural network.

18. A non-transitory computer-readable storage medium encoded with a computer program for controlling a multi-layer artificial neural network, the multi-layer artificial neural network comprising a plurality of artificial neurons for performing computation based on plural parameters, the computer program comprising instructions that when executed by one or more computers cause the one or more computers to perform operations comprising:
at a first time instant, providing a set of parameters corresponding to a first layer to the plurality of artificial neurons so that the plurality of artificial neurons form at least part of the first layer; and
at a second time instant, providing a set of parameters corresponding to a second layer to the plurality of artificial neurons so that the plurality of artificial neurons form at least part of the second layer.

19. The non-transitory computer-readable storage medium of claim 18, wherein when executed by the one or more computers, the instructions further cause the one or more computers to perform operations comprising:
controlling a configurable routing circuit coupled to the plurality of artificial neurons, so as to select input signals for the plurality of artificial neurons from either external data or previously stored internal data.

20. The non-transitory computer-readable storage medium of claim 19, wherein the previously stored internal data are generated by the plurality of artificial neurons.

21. The non-transitory computer-readable storage medium of claim 18, wherein when executed by the one or more computers, the instructions further cause the one or more computers to perform operations comprising:
controlling a configurable routing circuit coupled to the plurality of artificial neurons, so as to determine whether computation results of the plurality of artificial neurons are transmitted to external or not.

22. The non-transitory computer-readable storage medium of claim 18, wherein the first layer is a convolutional layer or a fully-connected layer.

23. The non-transitory computer-readable storage medium of claim 18, wherein when executed by the one or more computers, the instructions further cause the one or more computers to perform operations comprising:
analyzing external data of said multi-layer artificial neural network and accordingly determining a configuration for said multi-layer artificial neural network.

24. The non-transitory computer-readable storage medium of claim 23, wherein the determined configuration comprises a total number of layers of said multi-layer artificial neural network.
